(19) United States
(12) Patent Application Publication
(10) Pub. No.: US 2016/0077576 A1
(43) Pub. Date: Mar. 17, 2016

(54) TECHNOLOGIES FOR COLLABORATIVE HARDWARE AND SOFTWARE SCENARIO-BASED POWER MANAGEMENT

(71) Applicants: Abhinav R. Karhu, Hillsboro, OR (US); Guarav Khanna, Hillsboro, OR (US); Russell J. Fenger, Beaverton, OR (US)

(72) Inventors: Abhinav R. Karhu, Hillsboro, OR (US); Guarav Khanna, Hillsboro, OR (US); Russell J. Fenger, Beaverton, OR (US)

(21) Appl. No.: 14/488,805

(22) Filed: Sep. 17, 2014

(51) Int. Cl. G06F 1/32

(52) U.S. Cl. CPC G06F 1/3246; G06F 1/3293

(57) ABSTRACT

Technologies for collaborative hardware-software power management include a computing device having a processor that supports a low-power idle state. The low-power idle state may be connected standby or a low-power audio playback state. The computing device detects a present usage scenario and determines whether the usage scenario qualifies for a power boost. Qualifying usage scenarios may include low-power audio playback, screen-on interactive use, and I/O-bound workloads. For qualifying usage scenarios, the computing device applies a boosted power management policy that increases power consumption and performance compared to a default power management policy. The default power management policy may base performance and power consumption on recent processor utilization. The computing device may generate one or more hardware hints to increase performance and power consumption, such as increasing the processor p-state or setting the value of an energy performance bias register. Other embodiments are described and claimed.

### BACKGROUND

Energy efficiency is an increasingly important consideration for current computing devices. For portable devices such as laptops, tablets, and smartphones, energy efficiency directly affects battery life, which is an important part of the user experience. For server devices, energy efficiency directly affects cost, compute density, and thermal management. As a result, current processors typically support a balance of different performance and power consumption levels. Typically, a processor may be capable of scaling its performance and power consumption to improve performance under load and to reduce power consumption when idle or lightly loaded. Current processors and devices also support low-power usage models, which allow the device to achieve extremely low power consumption for certain usage models. For example, current computing devices may support connected standby, low-power audio playback, or other low-power states.

Typical computer operating systems may apply a default power management policy that sets the current processor performance level based on recent processor utilization. The operating system may periodically check processor utilization and set the performance level after each check. For example, when the processor is largely idle, the operating system may reduce the processor performance level, and when the processor utilization increases, the operating system may increase the processor performance level. As described above, processor performance level typically directly affects power consumption.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a computing device for collaborative hardware-software power management;

FIG. 2 is a simplified block diagram of at least one embodiment of an environment of the computing device of FIG. 1; and

FIG. 3 is a simplified flow diagram of at least one embodiment of a method for collaborative hardware-software power management that may be executed by the computing device of FIGS. 1 and 2.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

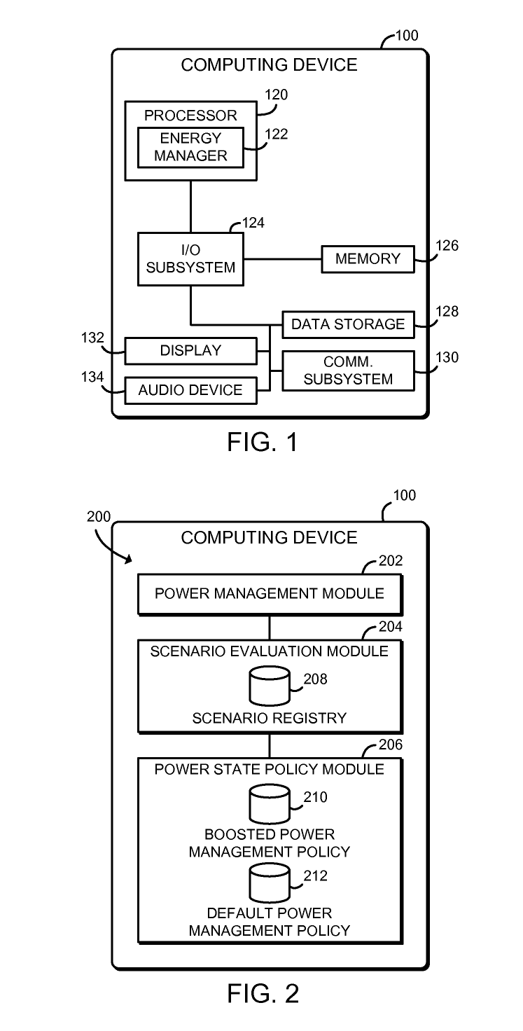

Referring now to FIG. 1, an illustrative computing device 100 for collaborative hardware-software power management includes a processor 120, an I/O subsystem 124, a memory 126, and a data storage device 128. In use, as described below, the computing device 100 is configured to cause the processor 120 to enter and exit from a low-power idle state. For certain usage scenarios and/or software workloads, the computing device 100 increases the performance and power consumption of the processor 120 and/or other components of the computing device 100 when leaving the low-power idle state. When the required processing is completed, the computing device 100 may cause the processor 120 to re-enter the low-powered idle state. Compared to default, un-boosted behavior, boosting the performance and power consumption of the computing device 100 may improve the responsiveness of the computing device 100 for certain interactive tasks. Additionally or alternatively, boosting performance and power consumption may cause the computing device 100 to complete processing more quickly, which in turn may cause the computing device 100 to return to the low-power idle state more quickly. Accordingly, boosting performance and power consumption may reduce overall energy consumption and improve battery life. Tables 1 and 2, below, list illustrative results that may be achieved using one embodiment of the computing device 100 of this disclosure. As shown, boosting the power state may increase battery life by several hours for a low-power audio playback scenario.

TABLE 1
Sample illustrative results for low-
power audio playback of m4a file.

| | Default | | Boosted | | | |
|---|---|---|---|---|---|---|
| | Power Policy | | Power Policy | | Δ | |
| Average power | 183 | mW | 167 | mW | −15.99 | mW |
| Low-power idle time | 91.7% | | 94.11% | | +2.41% | |
| Full-power time | 8.03% | | 5.67% | | −2.36% | |
| Battery life (38 W · h) | 207 | h | 227.5 | h | +20 | h |

TABLE 2
Sample illustrative results for low-
power audio playback of mp3 file.

| | Default | | Boosted | | | |
|---|---|---|---|---|---|---|
| | Power Policy | | Power Policy | | Δ | |
| Average power | 207 | mW | 197 | mW | −10 | mW |
| Battery life (38 W · h) | 183 | h | 192 | h | +9 | h |

The computing device 100 may be embodied as any type of device capable of performing collaborative hardware-software power management and otherwise performing the functions described herein. For example, the computing device 100 may be embodied as, without limitation, a laptop computer, a notebook computer, a tablet computer, a smartphone, a mobile computing device, a wearable computing device, a computer, a desktop computer, a workstation, a server computer, a distributed computing system, a multiprocessor system, a consumer electronic device, a smart appliance, and/or any other computing device capable of collaborative hardware-software power management. As shown in FIG. 1, the illustrative computing device 100 includes the processor 120, the I/O subsystem 124, the memory 126, and the data storage device 128. Of course, the computing device 100 may include other or additional components, such as those commonly found in a computer (e.g., various input/output devices), in other embodiments. Additionally, in some embodiments, one or more of the illustrative components may be incorporated in, or otherwise form a portion of, another component. For example, the memory 126, or portions thereof, may be incorporated in the processor 120 in some embodiments.

The processor 120 may be embodied as any type of processor capable of performing the functions described herein. For example, the processor 120 may be embodied as a single or multi-core processor(s), digital signal processor, microcontroller, or other processor or processing/controlling circuit. The processor 120 includes an energy manager 122, which may be embodied as any circuitry, firmware, microcode, or other component of the processor 120 allowing the processor 120 to adjust its performance and energy use. For example, the energy manager 122 may be configured to dynamically scale the frequency and/or voltage of the processor 120, gate or otherwise disable components of the processor 120, or cause the processor 120 to enter a low-power idle state such as sleep, suspend, hibernate, or connected standby. In some embodiments, the energy manager 122 may expose a software and/or firmware interface to allow software control of the performance and/or energy usage of the processor 120. For example, the energy manager 122 may enable one or more processor power states specified by the Advanced Configuration and Power Interface (ACPI) specification (e.g., c-states and/or e-states), one or more model-specific-registers (MSRs) exposing power management features of the processor 120, or other interface. The energy manager 122 may also consider other factors when adjusting the performance and power consumption of the processor 120, such as hardware capabilities, available power supply, thermal throttling limits, and other factors.

The memory 126 may be embodied as any type of volatile or non-volatile memory or data storage capable of performing the functions described herein. In operation, the memory 126 may store various data and software used during operation of the computing device 100 such operating systems, applications, programs, libraries, and drivers. The memory 126 is communicatively coupled to the processor 120 via the I/O subsystem 124, which may be embodied as circuitry and/or components to facilitate input/output operations with the processor 120, the memory 126, and other components of the computing device 100. For example, the I/O subsystem 124 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 124 may form a portion of a system-on-a-chip (SoC) and be incorporated, along with the processor 120, the memory 126, and other components of the computing device 100, on a single integrated circuit chip.

The data storage device 128 may be embodied as any type of device or devices configured for short-term or long-term storage of data such as, for example, memory devices and circuits, memory cards, hard disk drives, solid-state drives, or other data storage devices. The data storage device 128 may store operating system software, which may include one or more power management policies.

The computing device 100 may also include a communication subsystem 130, which may be embodied as any communication circuit, device, or collection thereof, capable of enabling communications between the computing device 100 and other remote devices over a computer network (not shown). The communication subsystem 130 may be configured to use any one or more communication technology (e.g., wired or wireless communications) and associated protocols (e.g., Ethernet, Bluetooth®, Wi-Fi®, WiMAX, etc.) to effect such communication. The computing device 100 may be capable of communication with remote devices using the communication subsystem 130 while the processor 120 is in a low-power idle state, such as connected standby.

Additionally, the computing device 100 may include a display 132 and an audio device 134. The display 132 may be embodied as any type of display capable of displaying digital information such as a liquid crystal display (LCD), a light emitting diode (LED), a plasma display, a cathode ray tube (CRT), or other type of display device. The audio device 134 may be embodied as any device or devices capable of generating audio signals for output, including a digital-to-analog converter (DAC), a codec, an audio output jack, a paper cone speaker, an audio transducer, and/or other type of audio device. The computing device 100 may be capable of performing certain functions while the processor 120 is in a low-power state and the display 132 is powered off. For example, the computing device 100 may generate audio signals by offloading audio processing to the audio device 134 while the processor 120 is in a low power audio state and the display 132 is powered off.

Referring now to FIG. 2, in the illustrative embodiment, the computing device 100 establishes an environment 200 during operation. The illustrative embodiment 200 includes a power management module 202, a scenario evaluation module 204, and a power state policy module 206. The various modules of the environment 200 may be embodied as hardware, firmware, software, or a combination thereof. For example, each of the modules, logic, and other components of the environment 200 may form a portion of, or otherwise be established by, the processor 120 or other hardware components of the computing device 100.

The power management module 202 is configured to cause the computing device 100 to enter and exit from a low-power idle state. The low-power idle state, also known as a platform idle state, may include any low-power state supported by the processor 120, the I/O subsystem 124, and/or other components of the computing device 100. The power management module 202 may be configured to provide a software or firmware interface to control power management of the processor 120, the I/O subsystem 124, and/or other components of the computing device 100. For example, the power management module 202 may implement or interface with an implementation of the Advanced Configuration and Power Interface (ACPI) specification.

The scenario evaluation module 204 is configured to detect the present usage scenario of the computing device 100 and determine whether the present usage scenario qualifies for a power boost. As described below, the present usage scenario may include any information describing the current software and/or hardware context of the computing device 100. The scenario evaluation module 204 may maintain a scenario registry 208 that includes one or more predefined usage scenarios. Matching against those usage scenarios may identify whether the present usage scenario qualifies for power boost or not.

The power state policy module 206 is configured to apply a boosted power management policy 210 if the present usage scenario qualifies for power boost and to apply a default power management policy 212 if the present usage scenario does not qualify for power boost. Each of the power management policies 210, 212 may include one or more rules for determining the level of performance and power consumption of the processor 120 and/or other components of the computing device 100. Applying the boosted power management policy 210 causes the processor 120 and/or other components of the computing device 100 to operate with increased performance and increased power consumption relative to the default power management policy 212. The power state policy module 206 may apply the power management policies 210, 212 by generating appropriate hints for hardware of the computing device 100. For example, the power state policy module 206 may interact with the energy manager 122 of the processor 120 to specify a desired performance level.

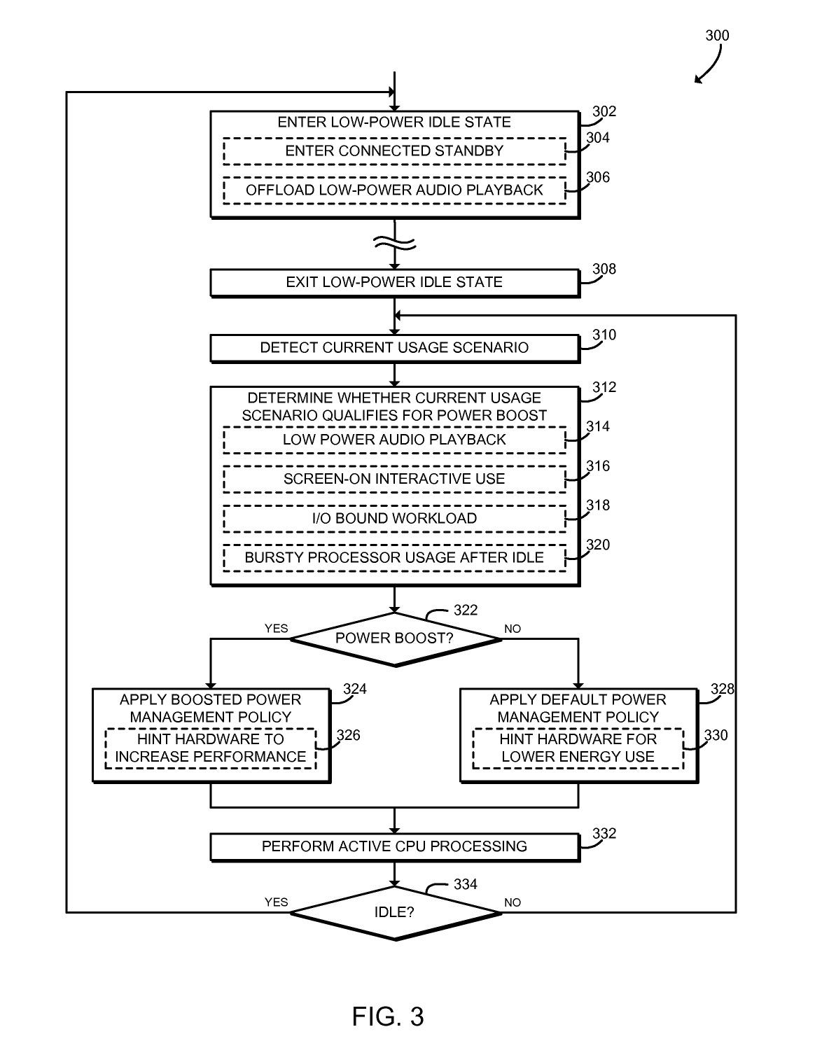

Referring now to FIG. 3, in use, the computing device 100 may execute a method 300 for collaborative hardware-software power management. The method 300 begins in block 302, in which the computing device 100 enters a low-power idle state. The low-power idle state may be any low-power state supported by the processor 120, the I/O subsystem 124, and/or other components of the computing device 100. In some embodiments, in block 304, the computing device 100 may enter a connected standby state, also known as an S0ix state. In the connected standby state, the processor 120 operates in a reduced-power-consumption mode but may be capable of limited processing, network connectivity, or other operations. The processor 120 may be capable of quickly transitioning out of the connected standby state into an active processing state, such as S0. Unlike a traditional suspend or standby state (e.g., ACPI S3), software may remain in-memory and active in the connected standby state, and the computing device 100 may maintain open network connections using the communication subsystem 130. In some embodiments, in block 306, the computing device 100 may enter a low-power audio playback state. In the low-power audio playback state, the processor 120 may offload audio playback tasks to the audio device 134. The audio device 134 may output an audio signal while the processor 120 is in a low-power idle state such as the connected standby state. As described below, the processor 120 may periodically wake from the low-power idle state to prepare additional audio data for playback.

The computing device 100 may continue in the low-power idle state for some time. In block 308, the computing device 100 exits the low-power idle state and enters an active processing state, such as the ACPI S0 state. The computing device 100 may exit the low-power idle state periodically or in response to one or more events such as interrupts, network activity, or user input. For example, prior to entering the low-power audio playback state, the processor 120 may prepare a fixed amount of audio data sufficient for playback of a certain length of time (e.g., one second). While the processor 120 is in the low-power idle state, the audio device 134 accesses the audio data and generates an output signal. In that example, the computing device 100 may exit from the low-power idle state periodically (e.g., every second) to prepare the next chunk of audio data for playback. Additionally or alternatively, the computing device 100 may exit the low-power idle state in response to a user input such as a button press to turn on the display 132 and/or otherwise activate the computing device 100. In some embodiments, the computing device 100 may exit the low-power idle state in response to an interrupt, such as a timer interrupt, an I/O device interrupt, an audio interrupt, a software-generated interrupt, or other interrupt.

In block 310, the computing device 100 detects the present usage scenario of the computing device 100. The present usage scenario may include any information describing the current software and/or hardware context of the computing device 100. For example, the present usage scenario may include the current user activity, currently running processes, whether the display 132 is powered on or off, whether audio is being played, current I/O activity, the length of time the computing device 100 was in the low-power idle state, processor usage, and other usage information.

In block 312, the computing device 100 determines whether the present usage scenario qualifies for a power boost. A usage scenario may be deemed to qualify for power boost if total energy efficiency of the computing device 100 may be increased by increasing the performance and power consumption of the processor 120 during that usage scenario. For example, boosting performance and power consumption may increase energy efficiency by allowing the computing device 100 to return to the low-power idle state more quickly (i.e., “race to sleep”). The computing device 100 may apply one or more heuristics to determine whether the present usage scenario qualifies for a power boost, or the computing device 100 may match the present usage scenario against one or more predefined usage scenarios. For example, the computing device 100 may compare the present usage scenario to one or more predefined usage scenarios included in the scenario registry 208. The scenario registry 208 may identify usage scenarios qualifying for power boost, or in some embodiments, usage scenarios that do not qualify for power boost.

In block 314, the computing device 100 may determine whether the present usage scenario includes low-power audio playback. As described above, low-power audio playback may include periodically waking the processor 120 from the low-power idle state to prepare a new chunk of audio data for playback before re-entering the low-power idle state. In block 316, the computing device 100 may determine whether the present usage scenario includes screen-on interactive use. Increasing power consumption of the processor 120 may improve user interface responsiveness, animation performance, or other interactive performance when exiting the processor idle state. In block 318, the computing device 100 may determine whether the present usage scenario includes an I/O-bound workload. For I/O-bound workloads, the processor 120 may idle in the low-power idle state while waiting for I/O interrupts that signal when one or more I/O operations are completed. In response to an interrupt, the processor 120 may prepare the next I/O operation before returning to the low-power idle state. In block 320, the computing device 100 may identify any usage scenario that includes a burst of high processor usage performed after exiting the low-power idle state. In those usage scenarios, increasing performance and power consumption may allow the processor 120 to complete processing more quickly and thereby return the computing device 100 to the low-power idle state more quickly. Thus, for those scenarios, the power boost may improve overall energy efficiency.

In block 322, the computing device 100 determines whether a power boost should be applied to the present usage scenario. If not, the method 300 branches to block 328, described below. If a power boost should be applied, the method 300 branches to block 324.

In block 324, the computing device 100 applies the boosted power management policy 210. The boosted power management policy 210 causes the processor 120 and/or other components of the computing device 100 to increase performance and increase power consumption. In some embodiments, in block 326 the computing device 100 may generate a hint to hardware of the computing device 100 to increase performance and power consumption. The processor 120 may adjust performance and power consumption based on hints provided by software, as well as based on other factors such as hardware capabilities, available power supply, thermal throttling limits, and other factors. For example, in some embodiments, the computing device 100 may increase the p-state of the processor 120. Increasing the p-state of the processor 120 causes the processor 120 to increase its frequency and/or voltage, thereby improving performance and increasing power consumption.

Additionally or alternatively, in some embodiments the computing device 100 may change the value of one or more energy performance bias (EPB) model-specific registers (MSRs). The processor 120 may adjust its internal balance of performance and power consumption based on the values provided to the EPB MSRs. Rather than specifying one or more discrete frequency levels for the processor 120, the EPB MSRs may allow software to specify a range of relative performance levels that the processor 120 attempts to achieve. For example, in some embodiments, the processor 120 may provide an IA32_ENERGY_PERF_BIAS register. The IA32_ENERGY_PERF_BIAS register may allow the computing device 100 to specify a four-bit value ranging from maximum performance to maximum energy saving. Additionally or alternatively, in some embodiments the processor 120 may support hardware-controlled performance states (HWP), which autonomously select performance state based on hints provided by software. The processor 120 may supply several MSRs, including registers to specify hints for minimum required performance, maximum expected performance, desired performance, energy performance preference, and other hints. After applying the boosted power management policy 210, the method 300 proceeds to block 332, described below.

Referring back to block 322, if power boost should not be applied, the method 300 branches to block 328. In block 328, the computing device 100 applies the default power management policy 212. The default power management policy 212 tends to specify lower performance and lower power consumption than the boosted power management policy 210. For example, the default power management policy 212 may set processor 120 performance and power usage based on recent utilization of the processor 120, increasing performance and power usage when recent utilization of the processor 120 has been high. The computing device 100 may periodically evaluate processor utilization (e.g., every 30 milliseconds) and adjust the processor 120 based on that evaluation. Thus, when exiting a low-power idle state when processor utilization is low, the processor 120 may initially execute in its lowest-performance active state. Even when fully utilized, the processor 120 may require one or more evaluation periods (e.g., at least 30 milliseconds) to ramp up to full performance and full power use. Server computing devices and operating systems, particularly, may have relatively long ramp-up periods to achieve full performance and power consumption. In some embodiments, in block 330 the computing device 100 may generate a hint to hardware of the computing device 100 to reduce power consumption and performance. For example, similar to the hints described above in connection with block 326, the computing device 100 may reduce the p-state of the processor 120, or specify reduced energy use and/or reduced performance using one or more EPB MSRs. After applying the default power management policy 212, the method 300 advances to block 332.

In block 332, the computing device 100 performs active processing using the processor 120. For example, the computing device 100 may perform calculations or other operations in the ACPI S0 and/or C0 active states, such as preparing audio data for playback, processing user interactions or animations, preparing an I/O operation, or other operations. The particular performance and power consumption of the computing device 100 during the active processor state depends on which power management policy 210, 212 has been applied.

In block 334, the computing device 100 determines whether to return to the low-power idle state. The computing device 100 may return to the low-power idle state, for example, when processing of a particular operation is completed, such as when audio data has been prepared for playback or when an I/O operation has been submitted to an I/O device. As another example, the computing device 100 may return to the low-power idle state in response to a user command, such as a command to turn off the display 132. If not returning to the low-power idle state, the method 300 loops back to block 310 to continue detecting the present usage scenario. If returning to the low-power idle state, the method 300 loops back to block 302 to enter the low-power idle state.

Although illustrated as detecting the present usage scenario, determining whether the current scenario qualifies for power boost, and applying the correct power management policy 210, 212 in response to exiting the low-power idle state, it should be understood that the computing device 100 may perform those operations at other times. For example, in some embodiments the computing device 100 may detect the present usage scenario and determine whether the present usage scenario qualifies for power boost in response to a requested change in usage, such as a user input, software command, or similar event. As another example, the computing device 100 may detect the present usage scenario independently from entering and exiting the low-power idle state, for example in a separate operating system task or thread. Similarly, in some embodiments the computing device 100 may apply the appropriate power management policies 210, 212 and generate corresponding hints for the hardware at any time, and the processor 120 and/or other components of the computing device 100 may select the appropriate balance of performance and power consumption automatically upon exiting the low-power idle state, without further input from software of the computing device 100.

### EXAMPLES

Illustrative examples of the technologies disclosed herein are provided below. An embodiment of the technologies may include any one or more, and any combination of, the examples described below.

Example 1 includes a computing device for collaborative hardware-software power management, the computing device comprising a scenario evaluation module to (i) detect a present usage scenario of the computing device, the present usage scenario including an exit from a low-power idle state by the computing device and (ii) determine whether the present usage scenario qualifies for power boost; and a power state policy module to (i) apply a boosted power management policy in response to a determination that the present usage scenario qualifies for power boost and (ii) apply a default power management policy in response to a determination that the present usage scenario does not quality for power boost, wherein the boosted power management policy defines a higher power consumption of the computing device relative to the default power management policy.

Example 2 includes the subject matter of Example 1, and wherein to apply the boosted power management policy comprises to apply the boosted power management policy in response to the exit of the low-power idle state; and to apply the default power management policy comprises to apply the default power management policy in response to the exit of the low-power idle state.

Example 3 includes the subject matter of any of Examples 1 and 2, and wherein to detect the present usage scenario comprises to detect the present usage scenario in response to the exit of the low-power idle state.

Example 4 includes the subject matter of any of Examples 1-3, and wherein the low-power idle state comprises a connected standby state.

Example 5 includes the subject matter of any of Examples 1-4, and wherein the low-power idle state comprises a low-power audio playback state.

Example 6 includes the subject matter of any of Examples 1-5, and wherein to determine whether the present usage scenario qualifies for power boost comprises to compare the present usage scenario against a registry of predefined usage scenarios.

Example 7 includes the subject matter of any of Examples 1-6, and wherein to determine whether the present usage scenario qualifies for power boost comprises to determine whether the present usage scenario is a low-power audio playback scenario.

Example 8 includes the subject matter of any of Examples 1-7, and wherein to determine whether the present usage scenario qualifies for power boost comprises to determine whether the present usage scenario is a screen-on interactive scenario.

Example 9 includes the subject matter of any of Examples 1-8, and wherein to determine whether the present usage scenario qualifies for power boost comprises to determine whether the present usage scenario is an I/O-bound workload scenario.

Example 10 includes the subject matter of any of Examples 1-9, and wherein to determine whether the present usage scenario qualifies for power boost comprises to determine whether the present usage scenario includes a burst of high processor usage that follows an idle period of the computing device.

Example 11 includes the subject matter of any of Examples 1-10, and wherein to apply the boosted power management policy comprises to hint a processor of the computing device to increase power consumption; and to apply the default power management policy comprises to hint the processor to decrease power consumption relative to the boosted power management policy.

Example 12 includes the subject matter of any of Examples 1-11, and wherein to hint the processor to increase power consumption comprises to increase a processor p-state of the computing device.

Example 13 includes the subject matter of any of Examples 1-12, and wherein to increase the processor p-state comprises to increase a processor frequency or a processor voltage.

Example 14 includes the subject matter of any of Examples 1-13, and wherein to hint the processor to decrease power consumption relative to the boosted power management policy comprises to set the processor p-state as a function of processor utilization of the computing device.

Example 15 includes the subject matter of any of Examples 1-14, and wherein to hint the processor to increase power consumption comprises to set an energy performance bias (EPB) model-specific register (MSR) of the processor to a first register value; and to hint the processor to decrease power consumption relative to the boosted power management policy comprises to set the EPB MSR to a second register value, wherein the first register value indicates a higher power consumption than the second register value.

Example 16 includes a method for collaborative hardware-software power management, the method comprising detecting, by a computing device, a present usage scenario of the computing device; determining, by the computing device, whether the present usage scenario qualifies for power boost; exiting, by a computing device, a low-power idle state during the present usage scenario; applying, by the computing device, a boosted power management policy in response to determining the present usage scenario qualifies for power boost; and applying, by the computing device, a default power management policy in response to determining the present usage scenario does not quality for power boost, wherein the boosted power management policy defines a higher power consumption of the computing device relative to the default power management policy.

Example 17 includes the subject matter of Example 16, and wherein applying the boosted power management policy comprises applying the boosted power management policy in response to exiting the low-power idle state; and applying the default power management policy comprises applying the default power management policy in response to exiting the low-power idle state.

Example 18 includes the subject matter of any of Examples 16 and 17, and wherein detecting the present usage scenario comprises detecting the present usage scenario in response to exiting the low-power idle state.

Example 19 includes the subject matter of any of Examples 16-18, and wherein exiting the low-power idle state comprises exiting a connected standby state.

Example 20 includes the subject matter of any of Examples 16-19, and wherein exiting the low-power idle state comprises exiting a low-power audio playback state.

Example 21 includes the subject matter of any of Examples 16-20, and wherein determining whether the present usage scenario qualifies for power boost comprises comparing the present usage scenario against a registry of predefined usage scenarios.

Example 22 includes the subject matter of any of Examples 16-21, and wherein determining whether the present usage scenario qualifies for power boost comprises determining whether the present usage scenario is a low-power audio playback scenario.

Example 23 includes the subject matter of any of Examples 16-22, and wherein determining whether the present usage scenario qualifies for power boost comprises determining whether the present usage scenario is a screen-on interactive scenario.

Example 24 includes the subject matter of any of Examples 16-23, and wherein determining whether the present usage scenario qualifies for power boost comprises determining whether the present usage scenario is an I/O-bound workload scenario.

Example 25 includes the subject matter of any of Examples 16-24, and wherein determining whether the present usage scenario qualifies for power boost comprises determining whether the present usage scenario includes a burst of high processor usage following an idle period of the computing device.

Example 26 includes the subject matter of any of Examples 16-25, and wherein applying the boosted power management policy comprises hinting a processor of the computing device to increase power consumption; and applying the default power management policy comprises hinting the processor to decrease power consumption relative to the boosted power management policy.

Example 27 includes the subject matter of any of Examples 16-26, and wherein hinting the processor to increase power consumption comprises increasing a processor p-state of the computing device.

Example 28 includes the subject matter of any of Examples 16-27, and wherein increasing the processor p-state comprises increasing a processor frequency or a processor voltage.

Example 29 includes the subject matter of any of Examples 16-28, and wherein hinting the processor to decrease power consumption relative to the boosted power management policy comprises setting the processor p-state as a function of processor utilization of the computing device.

Example 30 includes the subject matter of any of Examples 16-29, and wherein hinting the processor to increase power consumption comprises setting an energy performance bias (EPB) model-specific register (MSR) of the processor to a first register value; and hinting the processor to decrease power consumption relative to the boosted power management policy comprises setting the EPB MSR to a second register value, wherein the first register value indicates a higher power consumption than the second register value.

Example 31 includes a computing device comprising a processor; and a memory having stored therein a plurality of instructions that when executed by the processor cause the computing device to perform the method of any of Examples 16-30.

Example 32 includes one or more machine readable storage media comprising a plurality of instructions stored thereon that in response to being executed result in a computing device performing the method of any of Examples 16-30.

Example 33 includes a computing device comprising means for performing the method of any of Examples 16-30.

Example 34 includes a computing device for collaborative hardware-software power management, the computing device comprising means for detecting a present usage scenario of the computing device; means for determining whether the present usage scenario qualifies for power boost; means for exiting a low-power idle state during the present usage scenario; means for applying a boosted power management policy in response to determining the present usage scenario qualifies for power boost; and means for applying a default power management policy in response to determining the present usage scenario does not quality for power boost, wherein the boosted power management policy defines a higher power consumption of the computing device relative to the default power management policy.

Example 35 includes the subject matter of Example 34, and wherein the means for applying the boosted power management policy comprises means for applying the boosted power management policy in response to exiting the low-power idle state; and the means for applying the default power management policy comprises means for applying the default power management policy in response to exiting the low-power idle state.

Example 36 includes the subject matter of any of Examples 34 and 35, and wherein the means for detecting the present usage scenario comprises means for detecting the present usage scenario in response to exiting the low-power idle state.

Example 37 includes the subject matter of any of Examples 34-36, and wherein the means for exiting the low-power idle state comprises means for exiting a connected standby state.

Example 38 includes the subject matter of any of Examples 34-37, and wherein the means for exiting the low-power idle state comprises means for exiting a low-power audio playback state.

Example 39 includes the subject matter of any of Examples 34-38, and wherein the means for determining whether the present usage scenario qualifies for power boost comprises means for comparing the present usage scenario against a registry of predefined usage scenarios.

Example 40 includes the subject matter of any of Examples 34-39, and wherein the means for determining whether the present usage scenario qualifies for power boost comprises means for determining whether the present usage scenario is a low-power audio playback scenario.

Example 41 includes the subject matter of any of Examples 34-40, and wherein the means for determining whether the present usage scenario qualifies for power boost comprises means for determining whether the present usage scenario is a screen-on interactive scenario.

Example 42 includes the subject matter of any of Examples 34-41, and wherein the means for determining whether the present usage scenario qualifies for power boost comprises means for determining whether the present usage scenario is an I/O-bound workload scenario.

Example 43 includes the subject matter of any of Examples 34-42, and wherein the means for determining whether the present usage scenario qualifies for power boost comprises means for determining whether the present usage scenario includes a burst of high processor usage following an idle period of the computing device.

Example 44 includes the subject matter of any of Examples 34-43, and wherein the means for applying the boosted power management policy comprises means for hinting a processor of the computing device to increase power consumption; and the means for applying the default power management policy comprises means for hinting the processor to decrease power consumption relative to the boosted power management policy.

Example 45 includes the subject matter of any of Examples 34-44, and wherein the means for hinting the processor to increase power consumption comprises means for increasing a processor p-state of the computing device.

Example 46 includes the subject matter of any of Examples 34-45, and wherein the means for increasing the processor p-state comprises means for increasing a processor frequency or a processor voltage.

Example 47 includes the subject matter of any of Examples 34-46, and wherein the means for hinting the processor to decrease power consumption relative to the boosted power management policy comprises means for setting the processor p-state as a function of processor utilization of the computing device.

Example 48 includes the subject matter of any of Examples 34-47, and wherein the means for hinting the processor to increase power consumption comprises means for setting an energy performance bias (EPB) model-specific register (MSR) of the processor to a first register value; and the means for hinting the processor to decrease power consumption relative to the boosted power management policy comprises means for setting the EPB MSR to a second register value, wherein the first register value indicates a higher power consumption than the second register value.

1. A computing device for collaborative hardware-software power management, the computing device comprising:
a scenario evaluation module to (i) detect a present usage scenario of the computing device, the present usage scenario including an exit from a low-power idle state by the computing device and (ii) determine whether the present usage scenario qualifies for power boost; and
a power state policy module to (i) apply a boosted power management policy in response to a determination that the present usage scenario qualifies for power boost and (ii) apply a default power management policy in response to a determination that the present usage scenario does not quality for power boost, wherein the boosted power management policy defines a higher power consumption of the computing device relative to the default power management policy.

2. The computing device of claim 1, wherein:
to apply the boosted power management policy comprises to apply the boosted power management policy in response to the exit of the low-power idle state; and
to apply the default power management policy comprises to apply the default power management policy in response to the exit of the low-power idle state.

3. The computing device of claim 1, wherein to detect the present usage scenario comprises to detect the present usage scenario in response to the exit of the low-power idle state.

4. The computing device of claim 1, wherein the low-power idle state comprises a connected standby state.

5. The computing device of claim 1, wherein the low-power idle state comprises a low-power audio playback state.

6. The computing device of claim 1, wherein to determine whether the present usage scenario qualifies for power boost comprises to determine whether the present usage scenario is a screen-on interactive scenario.

7. The computing device of claim 1, wherein to determine whether the present usage scenario qualifies for power boost comprises to determine whether the present usage scenario is an I/O-bound workload scenario.

8. The computing device of claim 1, wherein to determine whether the present usage scenario qualifies for power boost comprises to determine whether the present usage scenario includes a burst of high processor usage that follows an idle period of the computing device.

9. The computing device of claim 1, wherein:
to apply the boosted power management policy comprises to hint a processor of the computing device to increase power consumption; and
to apply the default power management policy comprises to hint the processor to decrease power consumption relative to the boosted power management policy.

10. The computing device of claim 9, wherein to hint the processor to increase power consumption comprises to increase a processor p-state of the computing device.

11. The computing device of claim 9, wherein:
to hint the processor to increase power consumption comprises to set an energy performance bias (EPB) model-specific register (MSR) of the processor to a first register value; and
to hint the processor to decrease power consumption relative to the boosted power management policy comprises to set the EPB MSR to a second register value, wherein the first register value indicates a higher power consumption than the second register value.

12. A method for collaborative hardware-software power management, the method comprising:
detecting, by a computing device, a present usage scenario of the computing device;
determining, by the computing device, whether the present usage scenario qualifies for power boost;
exiting, by a computing device, a low-power idle state during the present usage scenario;
applying, by the computing device, a boosted power management policy in response to determining the present usage scenario qualifies for power boost; and
applying, by the computing device, a default power management policy in response to determining the present usage scenario does not quality for power boost, wherein the boosted power management policy defines a higher power consumption of the computing device relative to the default power management policy.

13. The method of claim 12, wherein exiting the low-power idle state comprises exiting a connected standby state.

14. The method of claim 12, wherein exiting the low-power idle state comprises exiting a low-power audio playback state.

15. The method of claim 12, wherein:
applying the boosted power management policy comprises hinting a processor of the computing device to increase power consumption; and
applying the default power management policy comprises hinting the processor to decrease power consumption relative to the boosted power management policy.

16. The method of claim 15, wherein hinting the processor to increase power consumption comprises increasing a processor p-state of the computing device.

17. The method of claim 15, wherein:
hinting the processor to increase power consumption comprises setting an energy performance bias (EPB) model-specific register (MSR) of the processor to a first register value; and
hinting the processor to decrease power consumption relative to the boosted power management policy comprises setting the EPB MSR to a second register value, wherein the first register value indicates a higher power consumption than the second register value.

18. One or more computer-readable storage media comprising a plurality of instructions that in response to being executed cause a computing device to:
detect a present usage scenario of the computing device;
determine whether the present usage scenario qualifies for power boost;
exit a low-power idle state during the present usage scenario;
apply a boosted power management policy in response to determining the present usage scenario qualifies for power boost; and
apply a default power management policy in response to determining the present usage scenario does not quality for power boost, wherein the boosted power management policy defines a higher power consumption of the computing device relative to the default power management policy.

19. The one or more computer-readable storage media of claim 18, wherein to exit the low-power idle state comprises to exit a connected standby state.

20. The one or more computer-readable storage media of claim 18, wherein to exit the low-power idle state comprises to exit a low-power audio playback state.

21. The one or more computer-readable storage media of claim 18, wherein to determine whether the present usage scenario qualifies for power boost comprises to determine whether the present usage scenario is an I/O-bound workload scenario.

22. The one or more computer-readable storage media of claim 18, wherein to determine whether the present usage scenario qualifies for power boost comprises to determine whether the present usage scenario includes a burst of high processor usage following an idle period of the computing device.

23. The one or more computer-readable storage media of claim 18, wherein:
to apply the boosted power management policy comprises to hint a processor of the computing device to increase power consumption; and
to apply the default power management policy comprises to hint the processor to decrease power consumption relative to the boosted power management policy.

24. The one or more computer-readable storage media of claim 23, wherein to hint the processor to increase power consumption comprises to increase a processor p-state of the computing device.

25. The one or more computer-readable storage media of claim 23, wherein:
to hint the processor to increase power consumption comprises to set an energy performance bias (EPB) model-specific register (MSR) of the processor to a first register value; and
to hint the processor to decrease power consumption relative to the boosted power management policy comprises to set the EPB MSR to a second register value, wherein the first register value indicates a higher power consumption than the second register value.
